(19) United States
(12) Patent Application Publication
(10) Pub. No.: US 2014/0196084 A1
(43) Pub. Date: Jul. 10, 2014

(54) SYSTEM AND METHOD FOR WORD RELEVANT CONTENT DELIVERY FOR TELEVISION MEDIA

(71) Applicant: SMRTV, Inc., Emeryville, CA (US)

(72) Inventors: Ian Aaron, Emeryville, CA (US); Alan Moskowitz, Emeryville, CA (US); Randall Cook, Emeryville, CA (US)

(73) Assignee: SMRTV, Inc., Emeryville, CA (US)

(21) Appl. No.: 14/149,714

(22) Filed: Jan. 7, 2014

Related U.S. Application Data
(60) Provisional application No. 61/749,832, filed on Jan. 7, 2013.

(51) Int. Cl. H04N 21/234; H04N 21/81

(52) U.S. Cl. CPC H04N 21/23424; H04N 21/812
USPC 725/34

(57) ABSTRACT

A system and method for delivering relevant content receives media data for television broadcasts comprising video or audio data and to extract target words from the media data. The system determines word relevant content based on the extracted target words and transmits the word relevant content to a user equipment.

### CROSS-REFERENCE TO RELATED APPLICATIONS

This application claims the benefit of U.S. Provisional Patent Application Ser. No. 61/749,832 entitled “SYSTEM AND METHOD FOR WORD RELEVANT CONTENT DELIVERY FOR TELEVISION MEDIA”, which was filed Jan. 7, 2013. The aforementioned application is herein incorporated by reference in its entirety.

### BACKGROUND

The television (TV) provides a remarkably accessible approach to delivering advertisement, typically in the form of commercials shown between program segments. In the United States, TV advertisement is generally considered the most effective mass-market advertising format and is reflected by the high prices of placing those advertisements.

However, advertising is generally broad and does not provide specific viewers with targeted content. One known approach of tailoring advertisements to the audience is by airing advertisements that are more likely to interest viewers of a particular TV show during the show's commercial breaks. In addition, TV advertising requires precious broadcast time that interrupts the regular TV programming. In this context, there remains a need for delivering more relevant content without interrupting regular TV programming.

### SUMMARY

The following presents a simplified summary of one or more implementations in order to provide a basic understanding of such implementations. This summary is not an extensive overview of all contemplated implementations, and is intended to neither identify key or critical elements of all implementations nor delineate the scope of any or all implementations. Its sole purpose is to present some concepts of one or more implementations in a simplified form as a prelude to the more detailed description that is presented later.

In accordance with one or more aspects of the implementations described herein, there is provided a system and method for delivering relevant content by a content provider. The content provider may receive media data for television broadcasts comprising video or audio data and to extract target words from the media data. The network entity may determine word relevant content based on the extracted target words and transmit the word relevant content to a user equipment.

### BRIEF DESCRIPTION OF THE DRAWINGS

FIG. 1 is a block diagram illustrating an example of a system for word relevant content delivery.

FIG. 2A illustrates an example word relevant content delivery methodology.

FIG. 2B shows further aspects of the methodology of FIG. 2A.

FIG. 3A illustrates an embodiment of an apparatus for word relevant content delivery.

FIG. 3B shows further aspects of the apparatus for word relevant content delivery of FIG. 3A.

### DETAILED DESCRIPTION

Various aspects are described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects. The word “exemplary” is used herein to mean “serving as an example, instance, or illustration.” Any embodiment described herein as “exemplary” is not necessarily to be construed as preferred or advantageous over other embodiments.

System and methods for relevant content delivery are described herein. As used herein, broadcast media generally refers to television and/or radio content transmitted through cable or over the air. The broadcast media may include digital or analog data signals. The broadcast media may include audio and video content that is organized into scheduled or unscheduled program segments. Extracting certain identifying information from the broadcast media allows identification of subjects mentioned in the broadcast media and allows for the delivery of more relevant content to viewers of the broadcast media.

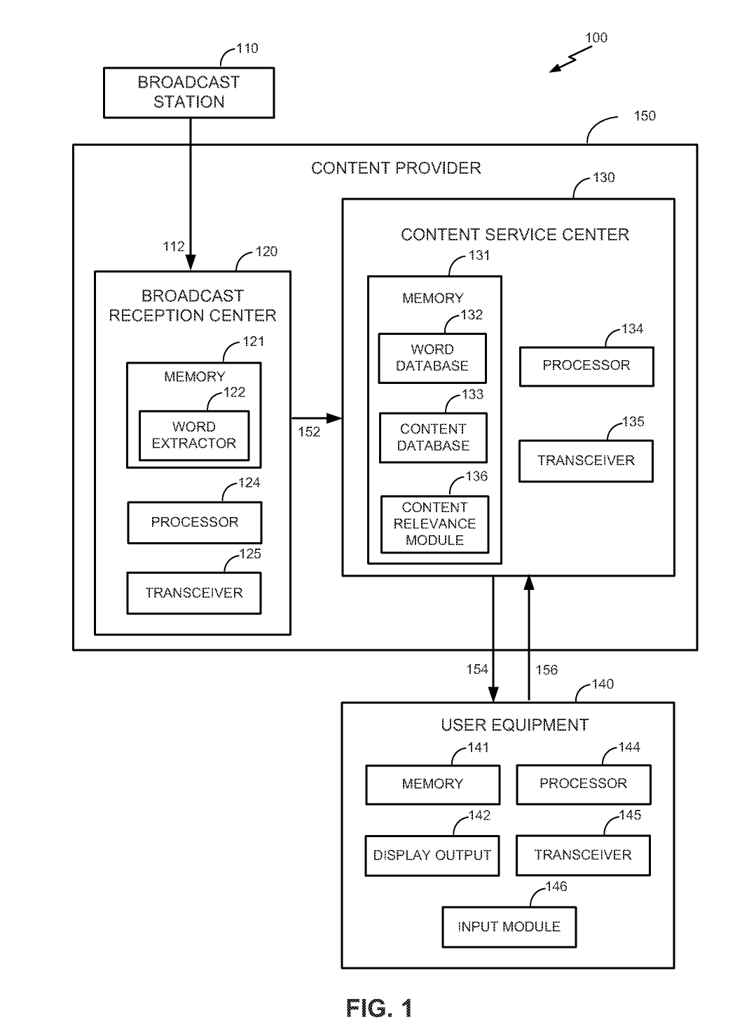

FIG. 1 shows an example system 100 in accordance with one or more aspects of the embodiments described herein. A broadcast station 110 transmits media data 112 to a broadcast reception center 120. In an example aspect, the broadcast reception center 120 may be part of a content provider 150. The broadcast station 110 may be a base station including a transmitter for broadcasting the media data 112. The broadcast station 110, for example, may be a television system broadcasting the media data 112 on a television channel over the air or through cable. Although FIG. 1 illustrates one block to represent a broadcast station 110, it is understood that that broadcast station 110 may refer to more than one facility located in different geographic areas. It is further understood that the one or more broadcast stations 110 may simultaneously transmit media data 112 over a plurality of channels or frequencies. For example, a different television program segment may be transmitted on each of a plurality of television channels.

The media data 112 may include at least one of audio, video data, or closed caption data. The transmission may be continuous or may start and stop over periods of time. The media data 112 may be in either analog or digital format. Example analog television systems, which are encoding or formatting standards, in current use are NTSC, PAL, and SECAM. In related aspects, digital television systems may use the MPEG transport stream format or the like.

The broadcast reception center 120 may be configured to receive the media data 112 from the broadcast station 110. Although FIG. 1 illustrates one block to represent the broadcast reception center 120, it is understood that the broadcast reception center 120 may refer to more than one facility located in different geographic areas. The broadcast reception center 120 may extract target words 152 from the media data 112. Target words 152 may be any individual word or any phrase including multiple words in any language. In some aspects, the target words 152 may be in an alphanumeric character format.

In one approach, a word extractor 122 in the broadcast reception center 120 may extract the target words 152 from audio data in the media data 112. For example, the audio data from spoken words on TV may be extracted with speech-to-text techniques into target words 152. In another approach, the target words 152 may be extracted from video data in the media data 112. For example, the video data from characters displayed on TV may be extracted with optical character recognition techniques.

In yet another approach, the target words 152 may be extracted from the media data 112 by decoding available closed caption data. Closed captioning is a process of displaying text on a TV to provide a transcription of spoken words or add additional information. For example, North American closed captions use EIA-608 encoding with National Television System Committee (NTSC) compatible video. For NTSC programming, captions are encoded into line 21 of the vertical blanking interval of the TV picture. For Advanced Television Systems Committee (ATSC) digital TV programming, three caption streams are encoded in the video.

In related aspects, the broadcast reception center 120 may extract all words spoken or written in the media data 112. In further related aspects, the broadcast receptor center 120 may selectively only extract words from a predefined list. For example, the predefined list may be configured to only include English words. In another example, the predefined list may include product names for commercial merchandise. In yet another example, the predefined list may include a list of hobbies, activities, and interests.

The broadcast reception center 120 may include a transceiver 125 configured to receive the media data 112 from the broadcast station 110 and to transmit the targeted words 152. A standalone receiver and/or standalone transmitter may be used in lieu of or in conjunction with the transceiver 125. The broadcast reception center 120 may optionally include a component for storing information, such as, for example, a memory device/component 121. The memory 121 may be configured to store computer readable instructions and data. The word extractor 122 may be stored as computer readable instructions in the memory 121. The broadcast reception center 120 may include a processor 124 configured to be able to read information from, write information to, the memory 121. The processor 124 may be configured to execute the word extractor 122 instructions stored in the memory 121 to extract the target words 152 from audio data in the media data 112. While shown as being external to the memory 121, it is to be understood that the components 124 and 125 can exist within the memory 121. It is further noted that the components of the broadcast reception center 120 in FIG. 1 may comprise electronic devices, hardware devices, electronic sub-components, logical circuits, memories, software codes, firmware codes, etc., or any combination thereof.

The broadcast reception center 120 may transmit the target words 152 to a content service center 130. In an example aspect, the content service center 130 may be part of the content provider 150. The content service center 130 may store the target words 152 received to a word database 132. In one related aspect, the content service center 130 may store additional data regarding the target words 152 in the word database 132. The additional information may include channel identification which identifies which TV broadcast channel the target words 152 were extracted from. The additional information may further include a broadcast time which identifies the time when the target words 152 were broadcasted.

In some aspects, data in the word database 132 concerning specific target words 152 may be offered to advertisers particularly interested in those specific target words. For example, a car manufacturer may be interesting in purchasing data concerning a target word 152 of the name of one of its car models. This data may determine how often the car model is mentioned in TV news programs of a particular channel. In another example, a mobile phone manufacturer may be interested in purchasing data concerning all target words 152 with “4G”. This data may determine which TV programs and channels have more or less content relating to 4G technology offered by its mobile phones and influence its future advertising decisions.

In on approach, the broadcast reception center 120 may store deliverable content in a content database 133. For example, the deliverable content may include advertising for products and services. In another example, the deliverable content may include encyclopedia information regarding various topics. In a related approach, the broadcast reception center 120 may obtain deliverable content not stored on the content database 133 from outside sources such as from content servers on a local area network or through the internet.

The content service center 130 may determine word relevant content 154 based on the target words 152 with a content relevance module 136. The word relevant content 154 may be chosen from the deliverable content that is available. For example, if the target word 152 is “snowboard”, the word relevant content 154 may be an advertisement video for a particular resort.

In a related aspect, the content service center 130 may receive viewing information 156 from a user equipment 140 (e.g., a smartphone, mobile personal computing device, or the like). The viewing information 156 may include viewing channel information specifying which TV broadcast channel a user of the user equipment 140 is viewing. The viewing information 156 may further include viewing time information regarding a previously recorded TV broadcast program being view by the user. In related aspects, the content service center 130 may determine word relevant content 154 further based on the viewing information 156 received from the user equipment 140. For example, if the viewing information 156 specifies that the user is watching a current live broadcast on NBC, the word relevant content 154 will be based on target words 152 recently spoken on NBC. In another example, if the viewing information 156 specifies that the user is watching a recorded Cartoon Network show broadcasted two hours ago, the word relevant content 154 will be based on target words 152 spoken on the Cartoon Network approximately two hours ago.

The content service center 130 may transmit the word relevant content 154 to the user equipment 140. In aspects without receiving viewing information 156 regarding which TV broadcast channel the user may be watching, word relevant content 154 for a plurality of TV broad cast channels may be sent to the user equipment 140. In other aspects with viewing information 156 available, bandwidth may be saved by sending only word relevant content 154 for a single channel that the user is watching.

The content service center 130 may include a transceiver 135 to receive the target words 152 from the broadcast reception center. The transceiver 135 may further receive viewing information 156 from and transmit word relevant content 154 to the user equipment 140. A standalone receiver and/or standalone transmitter may be used in lieu of or in conjunction with the transceiver 135. The content service center 130 may optionally include a component for storing information, such as, for example, a memory device/component 131. The memory 131 may be configured to store computer readable instructions and data. In related aspects, the word database 132 and the content database 133 may be stored in the memory 131. A content relevance module 136 may be stored as computer readable instructions in the memory 131. While shown as being external to the memory 131, it is to be understood that the components 134 and 135 can exist within the memory 131. The content service center 130 may include a processor 134 configured to be able to read information from, write information to, the memory 131. The processor 134 may be configured to execute the content relevance module 136 instructions stored in the memory 131 to determine word relevant content 154 based on the target words 152. It is further noted that the components in FIG. 1 may comprise electronic devices, hardware devices, electronic sub-components, logical circuits, memories, software codes, firmware codes, etc., or any combination thereof.

It is noted that the broadcast station 110, the broadcast reception center 120, and the content service center 130 are each shown as separate identities in FIG. 1, but any combination thereof may exist as a combined entity. For example, the broadcast reception center 120 may be combined with the content service center 130 and may share hardware and software components. The broadcast reception center 120 may be conceivably located onsite at the broadcast station 110 or may be located offsite. Similarly, the content service center 130 may be conceivably located onsite at the broadcast station 110 or may be located offsite. It is further noted that the broadcast reception center 120 and the content service center 130 may each include one or multiple electronic devices located at one or multiple locations.

The user equipment 140 may display the word relevant content 154 on a display output 142. For example, the display output 142 may display the word relevant content 154 onto the user's TV via a picture-in-picture or split screen scheme. In another example, the display output 142 may display the word relevant content 154 onto a second TV viewable by the user. In yet another example, the display output 142 may display the word relevant content 154 on display screen (e.g. LCD, LED, OLED, or the like) on the user equipment 140 itself.

The user equipment 140 may allow the user to input the viewing information 156 with an input module 146. In one approach, the input module 146 may be a keyboard, a touchscreen display, a mouse, or the like, which allows the user to input viewing channel information or viewing time information. In another approach, the input module 146 may use video or audio fingerprinting technology by sampling a piece of video or audio data from the TV to determine the viewing information 156.

The user equipment 140 may include a transceiver 145 to receive the word relevant content 154 from the content service center 130. The transceiver 145 may further transmit viewing information 156 to the content service center 130. A standalone receiver and/or standalone transmitter may be used in lieu of or in conjunction with the transceiver 145. The user equipment 140 may optionally include a component for storing information, such as, for example, a memory device/component 141. The memory 141 may be configured to store computer readable instructions and data. The user equipment 140 may include a processor 144 configured to be able to read information from, write information to, the memory 141. While shown as being external to the memory 141, it is to be understood that the components 142, 144, 145, and 146 can exist within the memory 141. It is further noted that the components in FIG. 1 may comprise electronic devices, hardware devices, electronic sub-components, logical circuits, memories, software codes, firmware codes, etc., or any combination thereof.

In view of exemplary systems shown and described herein, methodologies that may be implemented in accordance with the disclosed subject matter, will be better appreciated with reference to various flow charts. While, for purposes of simplicity of explanation, methodologies are shown and described as a series of acts/blocks, it is to be understood and appreciated that the claimed subject matter is not limited by the number or order of blocks, as some blocks may occur in different orders and/or at substantially the same time with other blocks from what is depicted and described herein. Moreover, not all illustrated blocks may be required to implement methodologies described herein. It is to be appreciated that functionality associated with blocks may be implemented by software, hardware, a combination thereof or any other suitable means (e.g., device, system, process, or component). Additionally, it should be further appreciated that methodologies disclosed throughout this specification are capable of being stored on an article of manufacture to facilitate transporting and transferring such methodologies to various devices. Those skilled in the art will understand and appreciate that a methodology could alternatively be represented as a series of interrelated states or events, such as in a state diagram.

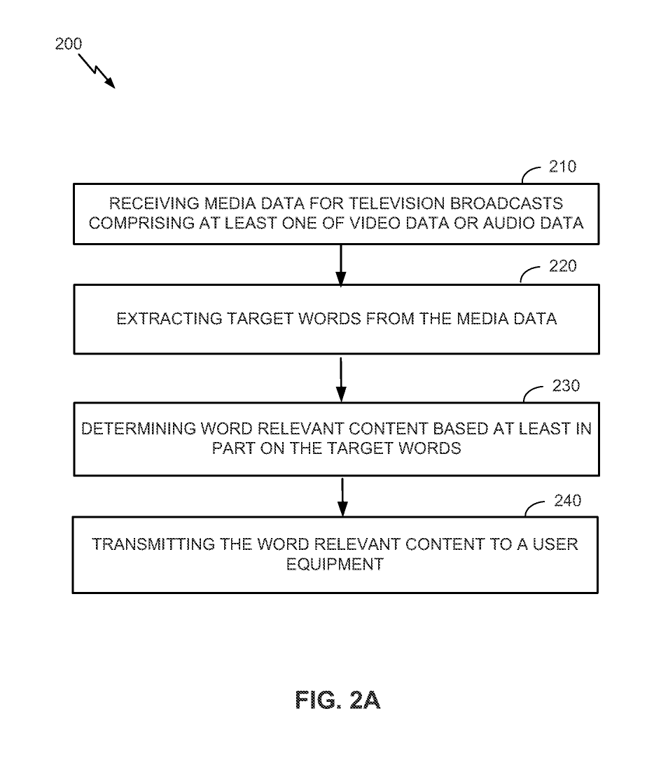

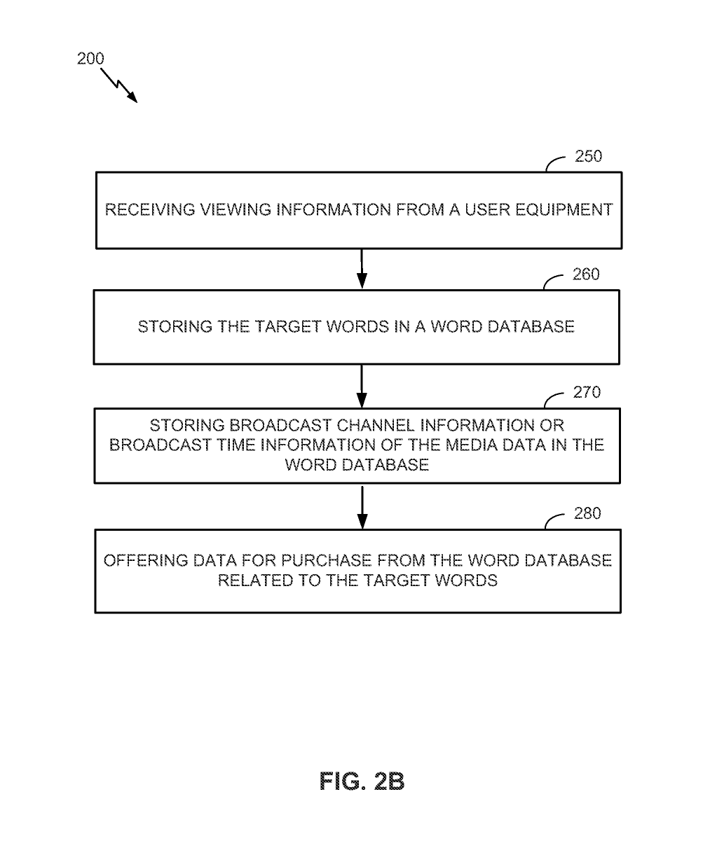

In accordance with one or more aspects of the embodiments described herein, with reference to FIG. 2A, there is shown a methodology 200 for word relevant content delivery. The method 200 may involve, at 210, receiving media data 112 for television broadcasts comprising at least one of video data or audio data. In an example implementation, the broadcast reception center 120 may receive the media data 112 from the broadcast station 110 via the transceiver 125.

The method 200 may involve, at 220, extracting target words 152 from the media data 112. In an example implementation, the word extractor 122 is a program located in the memory 121 of the broad reception center. The processor 124 may execute the word extractor 122 to extract target words 152 from the media data 112.

The method 200 may involve, at 230, determining word relevant content 154 based on the target words 152. In an example implementation, a processor 134 of the content service center 130 may execute a program in the memory 131 to determine the word relevant content 154.

The method 200 may involve, at 240, transmitting the word relevant content 154 to a user equipment 140. In an example implementation, the transceiver 135 of the content service center 130 may transmit the word relevant content 154 to the user equipment 140.

FIG. 2B show further optional operations or aspects of the method 200 described above with reference to FIG. 2A. If the method 200 includes at least one block of FIG. 2A, then the method 200 may terminate after the at least one block, without necessarily having to include any subsequent downstream block(s) that may be illustrated. It is farther noted that numbers of the blocks do not imply a particular order in which the blocks may be performed according to the method 200.

The method 200 may involve, at 250, receiving viewing information 156 from a user equipment 140. The method 200 may optionally involve, at 260, storing the target words 152 in a word database 132. The method may optionally involve at 270, storing broadcast channel information or broadcast time information of the media data 112 in the word database 132. The method 200 may optionally involve, at 280, offering data for purchase from the word database 132 related to the target words.

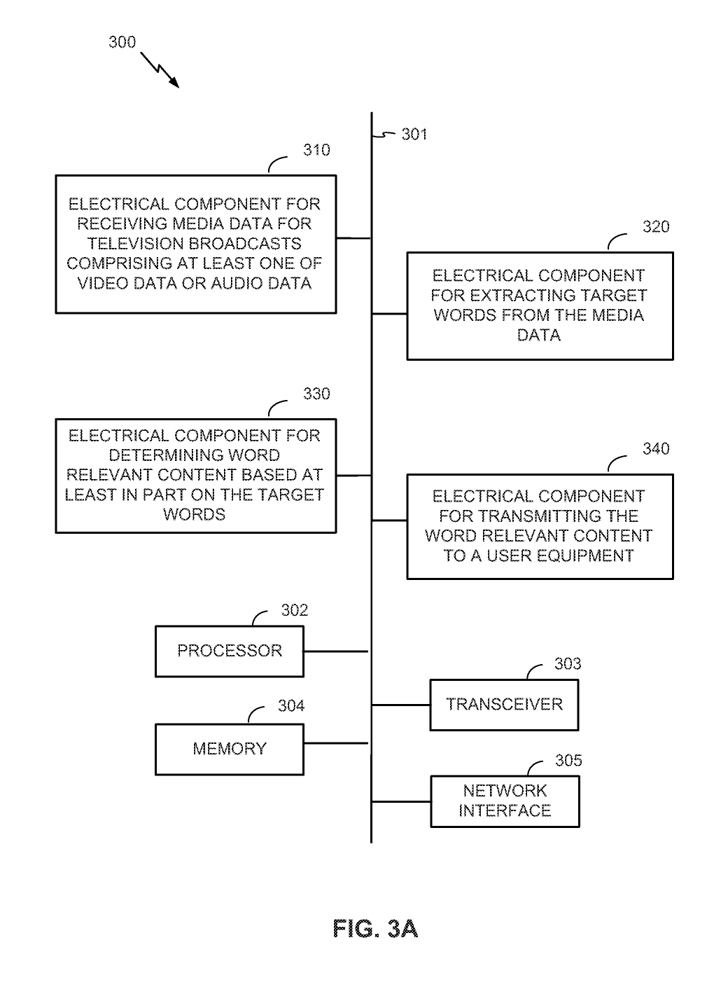

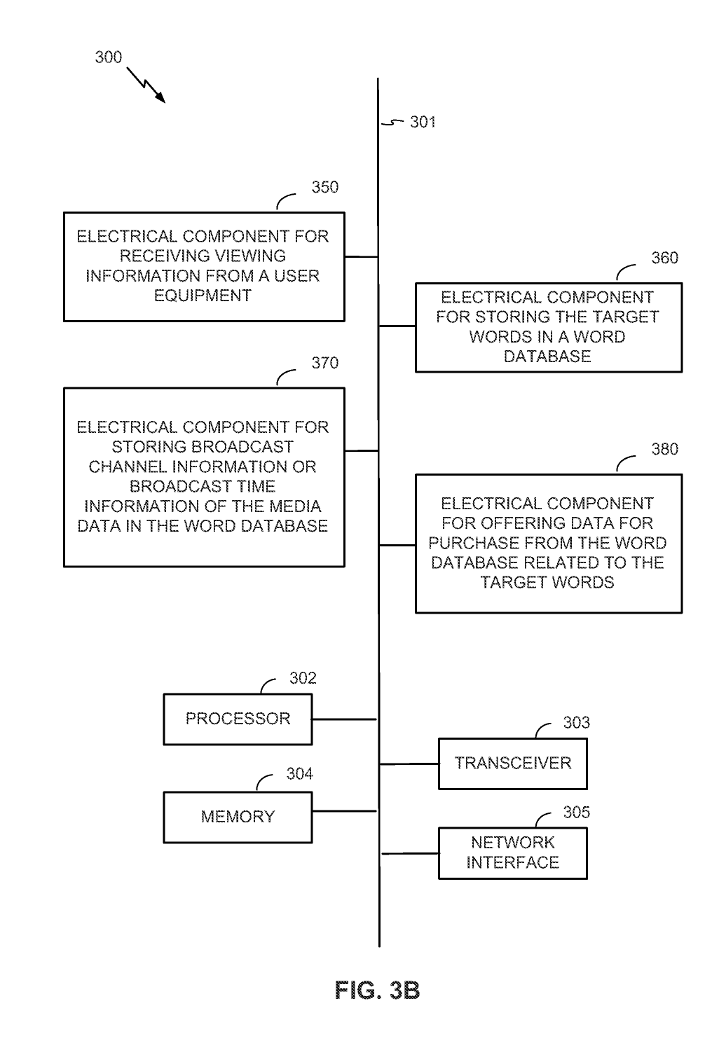

In accordance with one or more aspects of the embodiments described herein, FIG. 3A shows a design of an apparatus 300 for automated broadcast media identification. The exemplary apparatus 300 may be configured as a computing device or as a processor or similar device/component for use within. In one example, the apparatus 300 may include functional blocks that can represent functions implemented by a processor, software, or combination thereof (e.g., firmware). In another example, the apparatus 300 may be a system on a chip (SoC) or similar integrated circuit (IC).

In one embodiment, apparatus 300 may include an electrical component or module 310 for receiving media data 112 for television broadcasts comprising at least one of video data or audio data. For example, the component 310 may include the transceiver 125 working with the other components of the broadcast reception center 120 shown in FIG. 1.

The apparatus 300 may include an electrical component 320 for extracting target words 152 from the media data 112. For example, the component 320 may include the word extractor 122 of the broadcast reception center 120 shown in FIG. 1.

The apparatus 300 may include an electrical component 330 for determining word relevant content 154 based on the target words 152. For example, the component 330 may include the content relevance module 136 of the content service center 130 shown in FIG. 1.

The apparatus 300 may include an electrical component 340 for transmitting the word relevant content 154 to a user equipment 140. For example, the component 330 may include the transceiver 135 of the content service center 130 shown in FIG. 1.

In related aspects, as described in FIG. 3B, the apparatus 300 may optionally include an electrical component 350 for receiving viewing information 156 from a user equipment 140. The apparatus 300 may optionally include an electrical component 360 for storing the target words 152 in a word database 132. The apparatus 300 may optionally include an electrical component 370 for storing broadcast channel information or broadcast time information of the media data in the word database. The apparatus 300 may optionally include an electrical component 380 for offering data for purchase from the word database 132 related to the target words 152.

In further related aspects, the apparatus 300 may optionally include a processor component 302. The processor 302 may be in operative communication with the components 310-380 via a bus 301 or similar communication coupling. The processor 302 may effect initiation and scheduling of the processes or functions performed by electrical components 310-380.

In yet further related aspects, the apparatus 300 may include a radio transceiver component 303. A standalone receiver and/or standalone transmitter may be used in lieu of or in conjunction with the transceiver 303. The apparatus 300 may also include a network interface 305 for connecting to one or more other communication devices or the like. The apparatus 300 may optionally include a component for storing information, such as, for example, a memory device/component 304. The computer readable medium or the memory component 304 may be operatively coupled to the other components of the apparatus 300 via the bus 301 or the like. The memory component 304 may be adapted to store computer readable instructions and data for effecting the processes and behavior of the components 310-390, and subcomponents thereof, or the processor 302, or the methods disclosed herein. The memory component 304 may retain instructions for executing functions associated with the components 310-380. While shown as being external to the memory 304, it is to be understood that the components 310-380 can exist within the memory 304. It is further noted that the components in FIGS. 3A and 3B may comprise processors, electronic devices, hardware devices, electronic sub-components, logical circuits, memories, software codes, firmware codes, etc., or any combination thereof.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a non-transitory computer-readable medium. Non-transitory computer-readable media includes both computer storage media and communication media including any medium that facilitates transfer of a computer program from one place to another. A storage media may be any available media that can be accessed by a general purpose or special purpose computer. By way of example, and not limitation, such computer-readable media can include RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for relevant content delivery, comprising:
receiving media data for television broadcasts comprising a east one of video data or audio data;
extracting target words from the media data;
determining word relevant content based at least in part on the target words; and
transmitting the word relevant content to a user equipment.

2. The method of claim 1, wherein the extracting comprises decoding closed captions in the media data.

3. The method of claim 1, wherein the extracting comprises applying a speech-to-text technique to the media data.

4. The method of claim 1, wherein the extracting comprises applying an optical character recognition technique to the media data.

5. The method of claim 1, wherein the extracting extracts words from a predefined list.

6. The method of claim 1, further comprising receiving viewing information from a user equipment.

7. The method of claim 6, wherein viewing information comprises viewing channel information or viewing time information.

8. The method of claim 6, wherein the word relevant content is further based on the viewing information.

9. The method of claim 1, further comprising storing the target words in a word database.

10. The method of claim 9, further comprising storing broadcast channel information or broadcast time information of the media data in the word database.

11. The method of claim 9, further comprising offering data for purchase from the word database related to the target words.

12. The method of claim 1, wherein the user equipment is one of a television, a set up box, a mobile phone, a tablet device, or a personal computing device.

13. The method of claim 1, wherein the word relevant content comprises an advertisement.

14. The method of claim 1, wherein the network entity comprises at least one of a broadcast reception center or a content service center.

15. The method of claim 14, wherein at least one of the broadcast reception center or the content service center is located at a broadcast station.

16. The method of claim 14, wherein at least one of the broadcast reception center or the content service center is located at a remote station.

17. An apparatus, comprising:
a receiver configured to receive media data for television broadcasts comprising at least one of video data or audio data;
at least one processor configured to: extract a target words from the media data; and determine word relevant content based on the target words; and
a transmitter configured to transmit the word relevant content to a user equipment; and
a memory coupled to the at least one processor for storing data.

18. An apparatus, comprising:
means for receiving media data for television broadcasts comprising at least one of video data or audio data;
means for extracting a target words from the media data;
means for determining word relevant content based at least in part on the target words; and
means for transmitting the word relevant content to a user equipment.

19. A computer program product, comprising:
a non-transitory computer-readable medium comprising code for causing at least one computer to:
receive media data for television broadcasts comprising at least one of video data or audio data;
extract a target words from the media data;
determine word relevant content based at least in part on the target words; and
transmit the word relevant content to a user equipment.
